(19) United States
(12) Patent Application Publication
(10) Pub. No.: US 2025/0322799 A1
(43) Pub. Date: Oct. 16, 2025

(54) DISPLAY DEVICE AND METHOD OF SETTING AN EMISSION CONTROL SIGNAL OF THE DISPLAY DEVICE

(71) Applicant: SAMSUNG DISPLAY CO., LTD., YONGIN-SI (KR)

(72) Inventors: Seong Oh YEOM, Yongin-si (KR); Yu Chol KIM, Yongin-si (KR); Hong Soo KIM, Yongin-si (KR); Dong Gyu LEE, Yongin-si (KR); Eui Myeong CHO, Yongin-si (KR); Ja Kyoung JIN, Yongin-si (KR)

(21) Appl. No.: 18/921,139

(22) Filed: Oct. 21, 2024

(30) Foreign Application Priority Data
Apr. 15, 2024 (KR) 10-2024-0049891

(51) Int. Cl. G09G 3/3291

(52) U.S. Cl. CPC G09G 3/3291; G09G 2300/0842; G09G 2310/0237; G09G 2310/08

(57) ABSTRACT

A display device including: pixels connected to scan lines, data lines, and emission control lines; a data driver configured to supply a data signal to the data lines during a first cycle of a frame; an emission driver configured to supply a disable emission control signal and an enable emission control signal to the emission control lines during the first cycle and at least one other cycle within the frame, wherein the emission driver supplies the disable emission control signal with a first width during the first cycle, and with a second width different from the first width during at least one other cycle adjacent to the first cycle.

This application claims priority under 35 U.S.C. § 119 to Korean Patent Application No. 10-2024-0049891, filed on Apr. 15, 2024, the disclosure of which is incorporated by reference herein in its entirety.

### 1. TECHNICAL FIELD

The disclosure relates to a display device and a method for setting an emission control signal within the display device.

### 2. DESCRIPTION OF THE RELATED ART

As information technology advances, the importance of display devices, which serve as an interface between users and information, is becoming increasingly predominant. Consequently, the use of display devices such as liquid crystal displays and organic light emitting displays, is on the rise.

Recently, display devices are increasingly expected to support high-speed driving, which delivers images at a high frame frequency, and low-speed driving, which delivers images at a low frame frequency. There is a need for a method that minimizes flicker while maintaining consistent luminance when the display device operates at both high and low speeds.

### SUMMARY

An embodiment of the disclosure provides a display device and a method for setting an emission control signal of the display device that minimizes luminance differences within a single frame.

According to an embodiment of the disclosure, there is provided a display device including: pixels connected to scan lines, data lines, and emission control lines; a data driver configured to supply a data signal to the data lines during a first cycle of a frame; an emission driver configured to supply a disable emission control signal and an enable emission control signal to the emission control lines during the first cycle and at least one other cycle within the frame, wherein the emission driver supplies the disable emission control signal with a first width during the first cycle, and with a second width different from the first width during at least one other cycle adjacent to the first cycle.

The first cycle is a period in which a voltage of the data signal is stored in the pixels, and the at least other cycle is a period in which the pixels emit light and do not emit light while maintaining the voltage of the data signal.

The at least other cycle adjacent to the first cycle is a second cycle, a third cycle, or a fourth cycle.

The pixels do not emit light when the disable emission control signal is supplied to the emission control lines, and the pixels emit light when the enable emission control signal is supplied to the emission control lines.

According to an embodiment of the disclosure, there is provided a display device including: pixels connected to scan lines, data lines, and emission control lines; a data driver configured to supply a data signal to the data lines; an emission driver configured to supply a plurality of disable emission control signals and a plurality of enable emission control signals to the emission control lines during one frame period, wherein at least one of the plurality of disable emission control signals has a first width, and at least one of the plurality of disable emission control signals has a second width different from the first width.

At least one of the plurality of disable emission control signals has a third width different from the first width and the second width.

The emission driver sets a first disable emission control signal within the frame period to the first width.

The emission driver sets at least one of a second disable emission control signal, a third disable emission control signal, and a fourth disable emission control signal within the frame period to the second width.

The pixels do not emit light when the disable emission control signal is supplied to the emission control lines, and the pixels emit light when the enable emission control signal is supplied to the emission control lines.

According to an embodiment of the disclosure, there is provided a method of setting an emission control signal of a display device, wherein one frame includes a first cycle in which a data signal is supplied to pixels and a plurality of remaining cycles in which the pixels alternately emit and do not emit light while maintaining the data signal, the method including: measuring a frequency component while varying a width of the disable emission control signal to at least two different widths in response to a P-th cycle (where P is a natural number of 2 or more) within the remaining cycles; and setting the width of the disable emission control signal to a width that results in a lower frequency component for the P-th cycle.

The frequency component corresponding to the P-th cycle is measured when measuring the frequency component.

The disable emission control signal has a voltage that turns off the pixels when it is applied to the pixels.

A width of an emission control signal within the first cycle is predetermined.

A width of an emission control signal for the P-th cycle is set when a width of an emission control signal for a (P+1)-th cycle is predetermined.

The width of the emission control signal for the (P+1)-th cycle is equal to the width of the emission control signal for the first cycle.

A width of an emission control signal for a (P+1)-th cycle is varied when a width of an emission control signal for the P-th cycle is set.

According to an embodiment of the disclosure, there is provided a display device including: pixels connected to scan lines, data lines, and emission control lines; a data driver configured to supply a data signal to the data lines during a first period of a frame; an emission driver configured to supply a disable signal and an enable signal to the emission control lines during the first period and at least one additional period within the frame, wherein the emission driver supplies the disable signal with a first duration during the first period, and supplies the disable signal with a different duration during the at least one additional period within the frame.

In accordance with the display device and the method for setting the emission control signal described in the embodiments of the disclosure, the width of the emission control signal can be configured to account for all driving frequencies at which the display device operates. This approach helps to minimize luminance differences within a single frame period.

### BRIEF DESCRIPTION OF THE DRAWINGS

The above and other features of the disclosure will become more apparent by describing in detail embodiments thereof with reference to the accompanying drawings, in which:

FIG. 1 is a diagram illustrating a display device according to an embodiment of the disclosure;

FIG. 2 is a diagram illustrating an embodiment of a scan driver and an emission driver shown in FIG. 1;

FIG. 3 is a diagram illustrating a pixel according to an embodiment of the disclosure;

FIG. 4 is a waveform diagram illustrating an embodiment of a method of driving the pixel of FIG. 3 during a write period;

FIG. 5 is a waveform diagram illustrating an embodiment of a method of driving the pixel of FIG. 3 during a maintenance period;

FIG. 6 is a diagram illustrating a luminance of one frame period;

FIG. 7 is a flowchart illustrating a method of setting the width of a disable emission control signal according to an embodiment of the disclosure;

FIG. 8 is a diagram illustrating a process of setting the width of the disable emission control signal corresponding to the flowchart of FIG. 7;

FIGS. 9A and 9B are diagrams illustrating a frequency component of 180 Hz and 120 Hz, respectively;

FIG. 10 is a diagram illustrating a luminance of one frame period of a display device according to a comparative example and an embodiment of the disclosure;

FIG. 11 is a diagram illustrating a method of setting the width of a disable emission control signal according to an embodiment of the disclosure; and

FIG. 12 is a diagram illustrating a method of setting the width of a disable emission control signal according to an embodiment of the disclosure.

### DETAILED DESCRIPTION OF THE EMBODIMENTS

Hereinafter, various embodiments of the disclosure will be described in detail with reference to the accompanying drawings, enabling those skilled in the art to implement the disclosure with ease. It should be understood that the disclosure may be implemented in different forms and is not limited to the embodiments set forth herein.

To maintain clarity, elements not pertinent to the core description have been omitted, and identical or similar elements are consistently identified by the same reference numerals throughout the specification. Therefore, these reference numerals may also be applied in other drawings.

In addition, the phrase “is the same” in the description may be interpreted as “is substantially the same”. In other words, “is the same” should be understood by those of ordinary skill in the art to mean sufficiently similar to be considered the same. Other similar expressions may also have the implicit understanding that the term “substantially” is omitted.

Some embodiments are illustrated in the accompanying drawings using functional blocks, units, and/or modules. Those skilled in the art will understand that these blocks, units, and/or modules are physically implemented using various component such as logic circuits, individual components, microprocessors, hardwired circuits, memory elements, line connections, and other electronic circuits. These may be manufacture using semiconductor-based techniques or other suitable manufacturing techniques. Blocks, units, and/or modules implemented by a microprocessor or similar hardware may be programmed and controlled by software to perform various functions described herein, and may optionally be driven by firmware and/or software. In addition, each block, unit, and/or module may be implemented by dedicated hardware, or a combination of dedicated hardware for certain functions and a processor (for example, one or more programmed microprocessors and related circuits) for different functions. In some embodiments, the block, unit, and/or module may be physically separated into two or more interacting individual blocks, units, and/or modules. In other embodiments, the block, unit and/or module may be physically combined into more complex blocks, units, and/or modules.

The term “connection” between two configurations may refer to both electrical and physical connections inclusively, but is not limited to these. For example, “connection” in the context of a circuit diagram may mean an electrical connection, and “connection” in the context of a cross-sectional view or a plan view may mean a physical connection.

The use of terms such as “first,” “second,” and similar descriptors for various components is not intended to limit those components by these terms. These terms are used to distinguish one component from another component. Therefore, a first component described below may be a second component. The singular expression includes the plural expression unless the context clearly dictates otherwise.

Each of the embodiments disclosed below may be implemented alone or in combination with at least one of other embodiment.

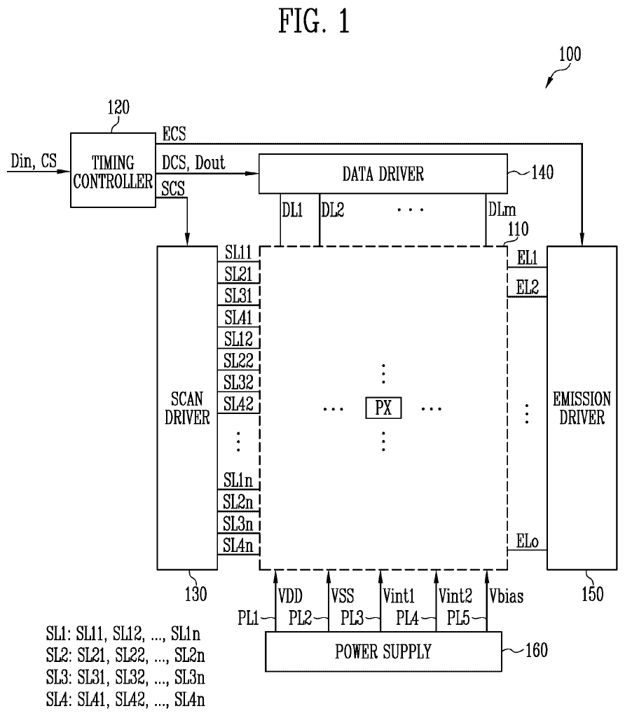

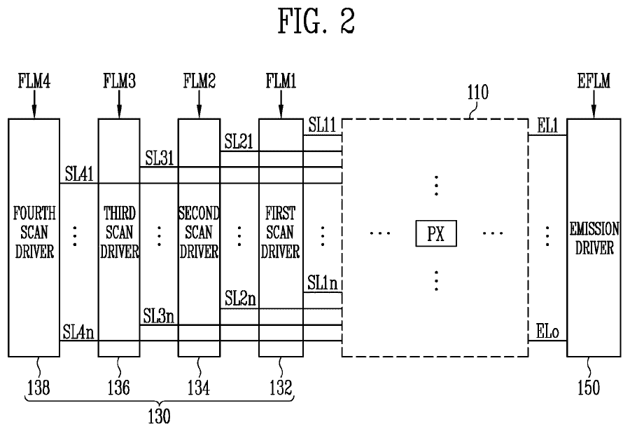

FIG. 1 is a diagram illustrating a display device according to an embodiment of the disclosure. FIG. 2 is a diagram illustrating an embodiment of a scan driver and an emission driver shown in FIG. 1.

Referring to FIG. 1, the display device 100 according to an embodiment of the disclosure may include a pixel unit 110 (or a display panel), a timing controller 120, the scan driver 130, a data driver 140, the emission driver 150, and a power supply 160 may be provided.

The display device 100 may display an image at various image refresh rates (driving frequencies, or screen reproduction rates) depending on driving conditions. The image refresh rate refers to the frequency at which a data signal is written to a driving transistor of a pixel PX. For example, the image refresh rate, also known as a screen scan rate or a screen reproduction rate, indicates the frequency at which a display screen is refreshed per second.

In an embodiment, the output frequency of the data driver 140 for one horizontal line (for example, pixels PX connected to the same scan line, which may be considered as a single horizontal line or pixel row) and/or the output frequency of a first scan driver 132 (see FIG. 2) that outputs a first scan signal (or a write scan signal) may be determined in accordance with the image refresh rate. For example, the image refresh rate for moving image driving may be a frequency of about 60 Hz or higher (for example, 120 Hz, 240 Hz, 360 Hz, or the like).

For example, the display device 100 may display images at various image refresh rates, ranging from 1 Hz to 360 Hz. However, this is an example, and the display device 100 may display an image at an image refresh rate of 360 Hz or higher (for example, 480 Hz).

The pixel unit 110 may include pixels PX connected to first scan lines SL11, SL12, . . . , and SL1n, second scan lines SL21, SL22, . . . , and SL2n, third scan lines SL31, SL32, . . . , and SL3n, fourth scan lines SL41, SL42, . . . , and SL4n, data lines DL1, DL2, . . . , and DLm, emission control lines EL1, EL2, . . . , and ELo, and power lines PL1, PL2, PL3, PL4, and PL5 (here, n, m, o are natural numbers equal to or greater than 2).

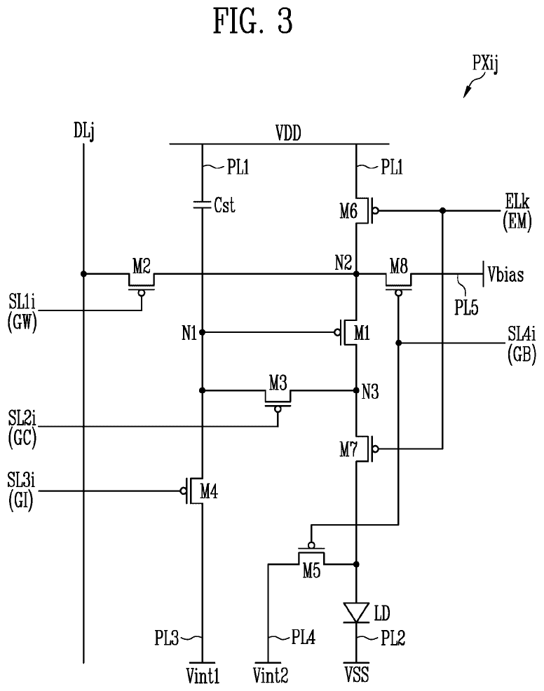

For example, a pixel PXij (refer to FIG. 3) positioned on an i-th horizontal line (or pixel row) and a j-th vertical line (or pixel column) may be connected to an i-th first scan line SL1i, an i-th second scan line SL2i, an i-th third scan line SL3i, an i-th fourth scan line SL4i, a k-th emission control line ELk, and a j-th data line DLj (here, i is a natural number equal to or less than n, j is a natural number equal to or less than m, and k is a natural number equal to or less than o). Here, k may be a number equal to i or less than i. For example, when each of the emission control lines EL1 to ELo is connected to a pixel PX positioned on one horizontal line, k may be the same number as i. For example, when each of the emission control lines EL1 to ELo is connected to pixels PX positioned on two or more horizontal lines, k may be a number less than i.

The pixels PX may be selected on a horizontal line basis when an enable first scan signal is supplied to the first scan lines SL11 to SL1n. The pixels PX selected by the enable first scan signal may receive a data signal from a data line (one of DL1 to DLm) connected thereto. The pixels PX that receive the data signal may emit light at a predetermined luminance in response to the voltage of the data signal.

The scan driver 130 may receive a scan driving signal SCS from the timing controller 120. The scan driving signal SCS may include at least one scan start signal and clock signals for driving the scan driver 130. The scan driver 130 may generate an enable first scan signal, an enable second scan signal, an enable third scan signal, and an enable fourth scan signal while shifting the scan start signal in response to the clock signal.

To achieve this, the scan driver 130 may include a first scan driver 132, a second scan driver 134, a third scan driver 136, and a fourth scan driver 138 as shown in FIG. 2. According to a design, at least some of the scan drivers 132, 134, 136, and 138 may be integrated into a single driver circuit, module, or similar component.

The first scan driver 132 may receive a first scan start signal FLM1 and generate the enable first scan signal by shifting the first scan start signal FLM1 in response to the clock signal. The first scan driver 132 may sequentially supply the enable first scan signal to the first scan lines SL11 to SL1n. In an embodiment, the first scan driver 132 may supply the enable first scan signal during a write period of an active period of one frame. In other words, the first scan driver 132 may supply the enable first scan signal during the write period of the active period within one frame.

The second scan driver 134 may receive a second scan start signal FLM2 and generate the enable second scan signal by shifting the second scan start signal FLM2 in response to the clock signal. The second scan driver 134 may sequentially supply the enable second scan signal to the second scan lines SL21 to SL2n. In an embodiment, the second scan driver 134 may supply the enable second scan signal during the write period of the active period of one frame. In other words, the second scan driver 134 may supply the enable second scan signal during the write period of the active period within one frame.

The third scan driver 136 may receive a third scan start signal FLM3 and generate the enable third scan signal by shifting the third scan start signal FLM3 in response to the clock signal. The third scan driver 136 may sequentially supply the enable third scan signal to the third scan lines SL31 to SL3n. In an embodiment, the third scan driver 136 may supply the enable third scan signal during the write period of the active period of one frame. In other words, the third scan driver 136 may supply the enable third scan signal during the write period of the active period within one frame.

The fourth scan driver 138 may receive a fourth scan start signal FLM4 and generate the enable fourth scan signal by shifting the fourth scan start signal FLM4 in response to the clock signal. The fourth scan driver 138 may sequentially supply the enable fourth scan signal to the fourth scan lines SL41 to SL4n. In an embodiment, the fourth scan driver 138 may supply the enable fourth scan signal during the write period of the active period of one frame. In other words, the fourth scan driver 138 may supply the enable fourth scan signal during the write period of the active period within one frame. In an embodiment, the fourth scan driver 138 may supply the enable fourth scan signal during a maintenance period that occurs within both an active period and a blank period of one frame.

For example, the fourth scan driver 138 may perform a scan once during the write period of one frame (in other words, supply at least one enable fourth scan signal) and perform additional scans at least once during the maintenance period of one frame, depending on the image refresh rate. If the image refresh rate decreases (in other words, the frame length increases), the blank period within the frame lengthens, resulting in more maintenance periods within the blank period. Consequently, as the image refresh rate decreases, the number of times the enable fourth scan signal is supplied increases.

Meanwhile, the enable first scan signal, the enable second scan signal, the enable third scan signal, and the enable fourth scan signal may be set to a gate-on voltage so that transistors included in the pixels PX may be turned on. For example, as shown in FIG. 3, an enable first scan signal GW, an enable second scan signal GC, an enable third scan signal GI, and an enable fourth scan signal GB supplied to a P-type transistor may be set to a low level voltage.

In FIG. 2, the first scan driver 132, the second scan driver 134, the third scan driver 136 and the fourth scan driver 138 are shown to be connected to the first scan line SL1, second scan line SL2, third scan line SL3, and fourth scan line SL4, respectively; however, an embodiment of the disclosure is not limited thereto. For example, at least two (at least two of SL1, SL2, SL3, and SL4) of the first scan line SL1, the second scan line SL2, the third scan line SL3, and the fourth scan line SL4 may be driven by one scan driver.

The data driver 140 may receive output data Dout and a data driving signal DCS from the timing controller 120. The data driving signal DCS may include sampling signals and/or timing signals for driving the data driver 140. The data driver 140 may generate a data signal based on the data driving signal DCS and the output data Dout. For example, the data driver 140 may generate an analog data signal based on a grayscale of the output data Dout. The data driver 140 may supply the data signal in one horizontal period unit.

The emission driver 150 may receive an emission driving signal ECS from the timing controller 120. The emission driving signal ECS may include an emission start signal and clock signals for driving the emission driver 150. The emission driver 150 may generate a disable emission control signal while shifting the emission start signal in response to the clock signal.

As shown in FIG. 2, the emission driver 150 may receive the emission start signal EFLM and generate the disable emission control signal while shifting the emission start signal EFLM in response to the clock signal. The emission driver 150 may sequentially supply the disable emission control signal to the emission control lines EL1 to ELo. The disable emission control signal may be set to a gate-off voltage so that the transistor included in the pixels PX may be turned off. For example, as shown in FIG. 3, the disable emission control signal EM supplied to a P-type transistor may be set to a high level voltage.

In an embodiment, the emission driver 150 may supply the disable emission control signal EM during both the write period and the maintenance period of a frame. For example, the emission driver 150 may perform a scan once during the write period and at least once during the maintenance period, depending on the image refresh rate. When the image refresh rate decreases (in other words, the frame length increases), the blank period within the frame also increases, leading to more maintenance periods within the blank period. As a result, with a lower image refresh rate, the number of times the disable emission control signal EM is supplied increases.

The timing controller 120 may receive input data Din and a control signal CS from a host system through an interface. For example, the timing controller 120 may receive the input data Din and the control signal CS from at least one of a graphics processing unit (GPU), a central processing unit (CPU), and an application processor (AP) included in the host system. The control signal CS may include various signals including a clock signal.

The timing controller 120 may generate the scan driving signal SCS, the data driving signal DCS, and the emission driving signal ECS based on the control signal CS. The scan driving signal SCS, the data driving signal DCS, and the emission driving signal ECS may be supplied to the scan driver 130, the data driver 140, and the emission driver 150, respectively.

The timing controller 120 may rearrange the input data Din to conform to the specification of the display device 100. In addition, the timing controller 120 may correct the input data Din to generate the output data Dout and supply the output data Dout to the data driver 140. In an embodiment, the timing controller 120 may correct the input data Din in response to an optical measurement result obtained during a process.

The power supply 160 may generate various power for driving the display device 100. For example, the power supply 160 may generate first driving power VDD, second driving power VSS, first initialization power Vint1, second initialization power Vint2, and bias power Vbias.

The first driving power VDD may be power that supplies a driving current to the pixels PX. The second driving power VSS may be power that receives the driving current from the pixels PX. During a period in which the pixels PX are set to an emission state, the first driving power VDD may be set to a voltage higher than that of the second driving power VSS.

The first initialization power Vint1 may be a power that initializes a gate electrode of the driving transistor included in each of the pixels PX. The first initialization power Vint1 may be set to a voltage lower than that of the data signal. The second initialization power Vint2 may be power that initializes a first electrode (or an anode electrode) of a light emitting element LD included in each of the pixels PX. The second initialization power Vint2 may be set to a voltage at which the light emitting element LD is turned off. The bias power Vbias may be power for applying an on bias voltage to the driving transistor included in each of the pixels PX.

The first driving power VDD generated by the power supply 160 may be supplied to a first power line PL1, the second driving power VSS may be supplied to a second power line PL2, the first initialization power Vint1 may be supplied to a third power line PL3, the second initialization power Vint2 may be supplied to a fourth power line PL4, and the bias power Vbias may be supplied to a fifth power line PL5. The first power line PL1, the second power line PL2, the third power line PL3, the fourth power line PL4, and the fifth power line PL5 are commonly connected to the pixels PX, but an embodiment of the disclosure is not limited thereto.

In an embodiment, the first power line PL1 may be configured of a plurality of power lines, and the plurality of power lines may be connected to different pixels PX. In an embodiment, the second power line PL2 may be configured of a plurality of power lines, and the plurality of power lines may be connected to different pixels PX. In an embodiment, the third power line PL3 may be configured of a plurality of power lines, and the plurality of power lines may be connected to different pixels PX. In an embodiment, the fourth power line PL4 may be configured of a plurality of power lines, and the plurality of power lines may be connected to different pixels PX. In an embodiment, the fifth power line PL5 may be configured of a plurality of power lines, and the plurality of power lines may be connected to different pixels PX. In other words, in an embodiment of the disclosure, the pixels PX may be connected to one of the first power line PL1, one of the second power line PL2, one of the third power line PL3, one of the fourth power line PL4, and one of the fifth power line PL5.

In an embodiment of the disclosure, the display device 100 may include a flat display device, a curved display device where a portion of the pixel unit 110 is bent, a flexible display device where a portion may be folded or bent, and a stretchable display device where a portion may be expanded and contracted.

In an embodiment of the disclosure, the display device 100 may be a device that displays a moving image or a still image, and may include a portable electronic device such as a mobile phone, a smart phone, a tablet personal computer, a smart watch, a watch phone, a mobile communication terminal, an electronic notebook, an e-book, a portable multimedia player (PMP), a navigation system, and an ultra mobile PC (UMPC). In an embodiment of the disclosure, the display device 100 may include an electronic device such as a television, a notebook computer, a monitor, a billboard, or Internet of things (IoT).

FIG. 3 is a diagram illustrating a pixel according to an embodiment of the disclosure. FIG. 3 shows a pixel positioned on an i-th horizontal line and a j-th vertical line.

Referring to FIG. 3, the pixel PXij according to an embodiment of the disclosure may be connected to corresponding signal lines SL1i, SL2i, SL3i, SL4i, ELk, and DLj. For example, the pixel PXij may be connected to the i-th first scan line SL1i, the i-th second scan line SL2i, the i-th third scan line SL3i, the i-th fourth scan line SL4i, the k-th emission control line Elk, and the j-th data line DLj. In an embodiment, the pixel PXij may be further connected to the first power line PL1, the second power line PL2, the third power line PL3, the fourth power line PL4, and the fifth power line PL5.

The pixel PXij according to an embodiment of the disclosure may include the light emitting element LD and a pixel circuit for controlling the amount of current supplied to the light emitting element LD.

The light emitting element LD may be connected between the first power line PL1 and the second power line PL2. For example, the first electrode (or the anode electrode) of the light emitting element LD may be electrically connected to the first power line PL1 via a seventh transistor M7, a third node N3, a first transistor M1, a second node N2, and a sixth transistor M6, and a second electrode (or a cathode electrode) of the light emitting element LD may be electrically connected to the second power line PL2. The light emitting element LD may generate light at a predetermined luminance in response to the current supplied from the first power line PL1 to the second power line PL2 through the pixel circuit.

The light emitting element LD may be an organic light emitting diode. In addition, the light emitting element LD may be an inorganic light emitting diode such as a micro light emitting diode (LED) or a quantum dot light emitting diode. In addition, the light emitting element LD may be an element configured of a composite of an organic material and an inorganic material. In FIG. 3, the pixel PXij is shown as including a single light emitting element LD. However, in another embodiment, the pixel PXij may include a plurality of light emitting elements LD, and the plurality of light emitting elements LD may be connected to each other in series, parallel, or series-parallel.

The pixel circuit may include the first transistor M1, a second transistor M2, a third transistor M3, a fourth transistor M4, a fifth transistor M5, the sixth transistor M6, the seventh transistor M7, an eighth transistor M8, and a storage capacitor Cst.

A first electrode of the first transistor M1 (or a driving transistor) may be connected to the second node N2, and a second electrode of the first transistor M1 may be connected to the third node N3. In addition, a gate electrode of the first transistor M1 may be connected to a first node N1. The first transistor M1 may control the driving current amount supplied from the first driving power VDD to the second driving power VSS through the light emitting element LD in response to the voltage at the first node N1.

The second transistor M2 may be connected between the data line DLj and the second node N2. In addition, a gate electrode of the second transistor M2 may be electrically connected to the first scan line SL1i. The second transistor M2 may be turned on when the enable first scan signal GW is supplied to the first scan line SL1i to electrically connect the data line DLj and the second node N2.

The third transistor M3 may be connected between the first node N1 and the third node N3. In addition, a gate electrode of the third transistor M3 may be electrically connected to the second scan line SL2i. The third transistor M3 may be turned on when the enable second scan signal GC is supplied to the second scan line SL2i to electrically connect the first node N1 and the third node N3. In other words, when the third transistor M3 is turned on, the first transistor M1 may be connected in a diode form.

A first electrode of the fourth transistor M4 may be connected to the first node N1, and a second electrode of the fourth transistor M4 may be electrically connected to the third power line PL3. In addition, a gate electrode of the fourth transistor M4 may be electrically connected to the third scan line SL3i. The fourth transistor M4 may be turned on when the enable third scan signal GI is supplied to the third scan line SL3i to supply a voltage of the first initialization power Vint1 to the first node N1.

A first electrode of the fifth transistor M5 may be connected to the first electrode of the light emitting element LD, and a second electrode of the fifth transistor M5 may be electrically connected to the fourth power line PL4. In addition, a gate electrode of the fifth transistor M5 may be electrically connected to the fourth scan line SL4i. The fifth transistor M5 may be turned on when the enable fourth scan signal GB is supplied to the fourth scan line SL4i to supply a voltage of the second initialization power Vint2 to the first electrode of the light emitting element LD.

When the voltage of the second initialization power Vint2 is supplied to the first electrode of the light emitting element LD, a parasitic capacitor of the light emitting element LD may be discharged. As the residual voltage in the parasitic capacitor of the light emitting element LD is discharged (or removed), unintentional micro-emissions may be prevented. Therefore, a black expression ability of the pixel PXij may be improved. In other words, this may enhance the pixel PXij's ability to display true black.

A first electrode of the sixth transistor M6 may be electrically connected to the first power line PL1, and a second electrode of the sixth transistor M6 may be connected to the second node N2. In addition, a gate electrode of the sixth transistor M6 may be electrically connected to the emission control line ELk. The sixth transistor M6 may be turned on when the disable emission control signal EM is supplied to the emission control line Elk, and may be turned on when the enable emission control signal EM is supplied.

The seventh transistor M7 may be connected between the third node N3 and the first electrode of the light emitting element LD. In addition, a gate electrode of the seventh transistor M7 may be electrically connected to the emission control line ELk. The seventh transistor M7 may be turned off when the disable emission control signal EM is supplied to the emission control line Elk, and may be turned on when the enable emission control signal EM is supplied.

A first electrode of the eighth transistor M8 (or a bias transistor) may be electrically connected to the fifth power line PL5, and a second electrode of the eighth transistor M8 may be connected to the second node N2. In addition, a gate electrode of the eighth transistor M8 may be electrically connected to the fourth scan line SL4i. The eighth transistor M8 may be turned on when the enable fourth scan signal GB is supplied to the fourth scan line SL4i to electrically connect the fifth power line PL5 and the second node N2.

The storage capacitor Cst may be connected between the first power line PL1 and the first node N1. The storage capacitor Cst may store a voltage applied to the first node N1.

In FIG. 3, the transistors M1 to M8 are shown as P-type transistors, but an embodiment of the disclosure is not limited thereto. Some (for example, M3 and M4) of the transistors M1 to M8 may be N-type transistors.

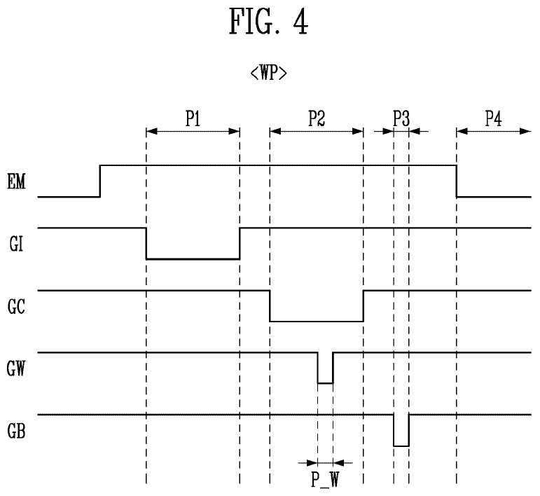

FIG. 4 is a waveform diagram illustrating an embodiment of a method of driving the pixel of FIG. 3 during the write period. The write period WP may be included in the active period of the frame.

Referring to FIGS. 3 and 4, the write period WP may include a first period P1, a second period P2, a third period P3, and a fourth period P4. The first period P1 to the third period P3 may be a non-emission period, and the fourth period P4 may be an emission period.

The disable emission control signal EM may be supplied to the emission control line ELk during the first period P1 to the third period P3. The disable emission control signal EM may have a high level during the first period P1 to the third period P3. When the disable emission control signal EM is supplied to the emission control line ELk, the sixth transistor M6 and the seventh transistor M7 are turned off. When the sixth transistor M6 and the seventh transistor M7 are turned off, an electrical connection between the first power line PL1 and the light emitting element LD is cut off, and thus, the light emitting element LD is set to a non-emission state.

During the first period P1, the enable third scan signal GI is supplied to the third scan line SL3i. In this case, the enable third scan signal GI may have a low level. When the enable third scan signal GI is supplied to the third scan line SL3i, the fourth transistor M4 is turned on. When the fourth transistor M4 is turned on, the voltage of the first initialization power Vint1 of the third power line PL3 may be supplied to the first node N1. When the voltage of the first initialization power Vint1 is supplied to the first node N1, the first transistor M1 may be set to a strong “on” bias state.

During the second period P2, the enable second scan signal GC is supplied to the second scan line SL2i, and thus, the third transistor M3 is turned on. In this case, the enable second scan signal GC may have the low level. When the third transistor M3 is turned on, the first transistor M1 may be connected in a diode form.

The enable first scan signal GW is supplied to the first scan line SL1i in a write period P_W overlapping the second period P2. In other words, the write period P_W may occur during the second period P2. When the enable first scan signal GW is supplied to the first scan line SL1i, the second transistor M2 is turned on. When the second transistor M2 is turned on, the data signal may be supplied from the data line DLj to the second node N2. Since the first transistor M1 maintains a diode-connected form due to the turned-on third transistor M3, the first node N1 may have a voltage that compensates for the threshold voltage of the first transistor M1 in the data signal.

During the third period P3, the enable fourth scan signal GB is supplied to the fourth scan line SL4i. When the enable fourth scan signal GB is supplied to the fourth scan line SL4i, the fifth transistor M5 and the eighth transistor M8 are turned on. When the fifth transistor M5 is turned on, the voltage of the second initialization power Vint2 may be supplied to the first electrode of the light emitting element LD, and thus, the light emitting element LD may be initialized. When the eighth transistor M8 is turned on, a voltage of the bias power Vbias is supplied to the second node N2. When the voltage of the bias power Vbias is supplied to the second node N2, the first transistor M1 may be set to the “on” bias state.

In the fourth period P4, the enable emission control signal EM (or a low level emission control signal) is supplied to the emission control line ELk, and thus, the sixth transistor M6 and the seventh transistor M7 are turned on. When the sixth transistor M6 and the seventh transistor M7 are turned on, a current path is established, connecting the second power line PL2 via the first power line PL1, the sixth transistor M6, the first transistor M1, the seventh transistor M7, and the light emitting element LD. At this time, the first transistor M1 controls the driving current corresponding to the voltage at the first node N1, allowing it to flow through the light emitting element LD, which then generates light with a luminance corresponding to the driving current.

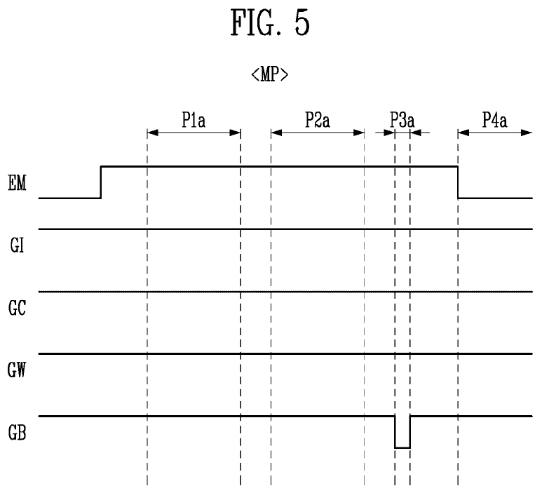

FIG. 5 is a waveform diagram illustrating an embodiment of a method of driving the pixel of FIG. 3 during the maintenance period. The maintenance period MP is a period in which light is emitted while maintaining the voltage of a previously supplied data signal, allowing an image to be displayed without switching to a new frame. In an embodiment, one frame may include one write period WP in the active period. In an embodiment, a frame may include at least one maintenance period MP in response to the image refresh rate. If a frame includes a plurality of maintenance periods MP, the plurality of maintenance periods MP may be arranged consecutively after the write period WP.

In the maintenance period MP, compared to the write period WP, the threshold voltage compensation and data writing operations may be omitted. Instead, the bias voltage may be applied to the first transistor M1, and the light emitting element LD may be initialized. The maintenance period MP may be set to a length similar to that of the write period WP. The maintenance period MP may include a first period P1a, a second period P2a, a third period P3a, and a fourth period P4a.

Referring to FIGS. 3 and 5, the disable emission control signal EM is supplied to the emission control line Elk in the first to third periods P1a to P3a. When the disable emission control signal EM is supplied to the emission control line ELk, the sixth transistor M6 and the seventh transistor M7 are turned off, and thus the light emitting element LD is set to a non-emission state.

The enable first scan signal GW, the enable second scan signal GC, and the enable third scan signal GI are not supplied in the first period P1a to the third period P3a. In other words, the disable scan signals GW, GC, and GI are supplied in the first period P1a to the third period P3a. Accordingly, in the first period P1a to the third period P3a, the second transistor M2, the third transistor M3, and the fourth transistor M4 are set to a turn-off state.

The enable fourth scan signal GB may be supplied to the fourth scan line SL4i in the third period P3a. When the enable fourth scan signal GB is supplied to the fourth scan line SL4i, the fifth transistor M5 and the eighth transistor M8 may be turned on.

When the fifth transistor M5 is turned on, the voltage of the second initialization power Vint2 may be supplied to the first electrode of the light emitting element LD, thereby initializing the light emitting element LD.

When the eighth transistor M8 is turned on, the bias power Vbias voltage is supplied to the second node N2. With the bias power Vbias at the second node N2, the first transistor M1 may be set to the on bias state.

The display device 100 described in this embodiment can be driven at various driving frequencies (frame frequencies) because each frame includes the write period WP and the maintenance period MP.

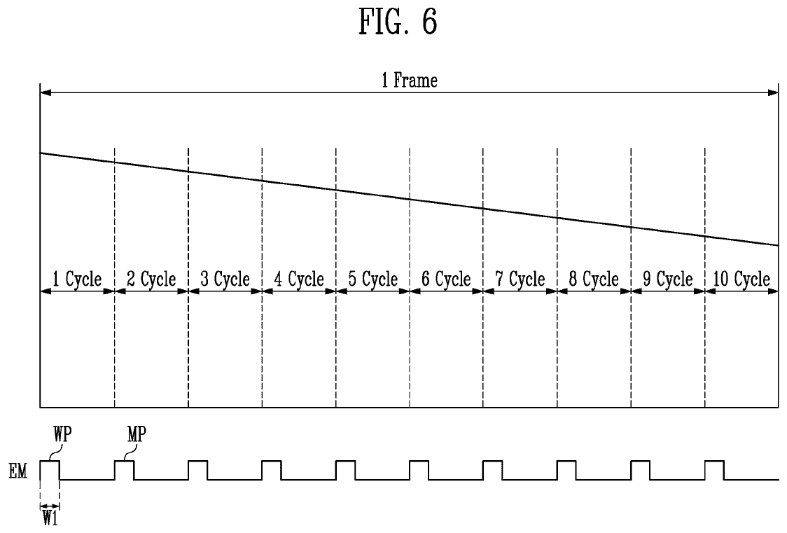

FIG. 6 is a diagram illustrating a luminance of one frame period. FIG. 6 shows a luminance of pixels positioned on one horizontal line. A part labeled as Cycle in FIG. 6 may represent a period during which the pixels PX transition between non-emission and emission states in response to a single emission control signal EM. In FIG. 6, it is assumed that 10 disable emission control signals EM are supplied (10 cycles are included) during one frame period.

In an embodiment, an initial period of one frame may include the write period WP. During the write period WP, a voltage corresponding to the data signal may be stored in the pixels PX, and during the maintenance period MP, the pixels PX may transition between emission and non-emission states while maintaining the voltage of the data signal stored in the write period WP.

The number of maintenance periods MP included in one frame can be adjusted according to the driving frequency (i.e., the image refresh rate). For example, the length of the blank period (blank area) in one frame may vary depending on the driving frequency, which in turn adjusts the number of maintenance periods MP included in that frame.

Referring to FIG. 6, the luminance of a specific horizontal line may gradually decrease during a single frame period. When this decrease in luminance occurs during one frame period, flickering may be observed in the display device 100 because the luminance of the frame is not maintained constant.

To mitigate this issue, a method of setting the width of the emission control signal based on the driving frequency of the display device 100 is proposed. For example, the width of the emission control signal may be set differently when the display device 100 operates at 120 Hz, compared to when the display device 100 operates at 90 Hz.

In this case, different lookup tables (for example, storing the width of the emission control signal) are applied for each driving frequency of the display device 100. However, when the driving frequency of the display device 100 changes in real time, controlling the width of the emission control signal using multiple lookup tables (LUTs) becomes challenging.

In general, when the display device 100 is driven at various driving frequencies, the width of the disable emission control signal EM is determined based on the minimum driving frequency (for example, 20 Hz, 1 Hz, or the like) that the display device 100 can support. In this case, flickering or similar issue may occur when the display device 100 is driven at an intermediate frequency between the highest and lowest frequencies.

In an embodiment of the disclosure, the width of the disable emission control signal EM can be adjusted based on various driving frequencies at which the display device 100 operates. By doing so, the luminance variation within a single frame can be minimized, thereby reducing the occurrent of flicker.

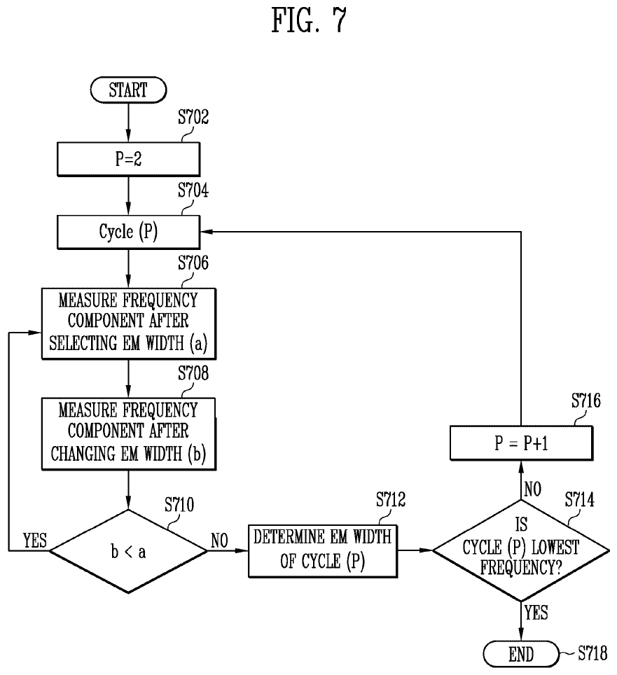

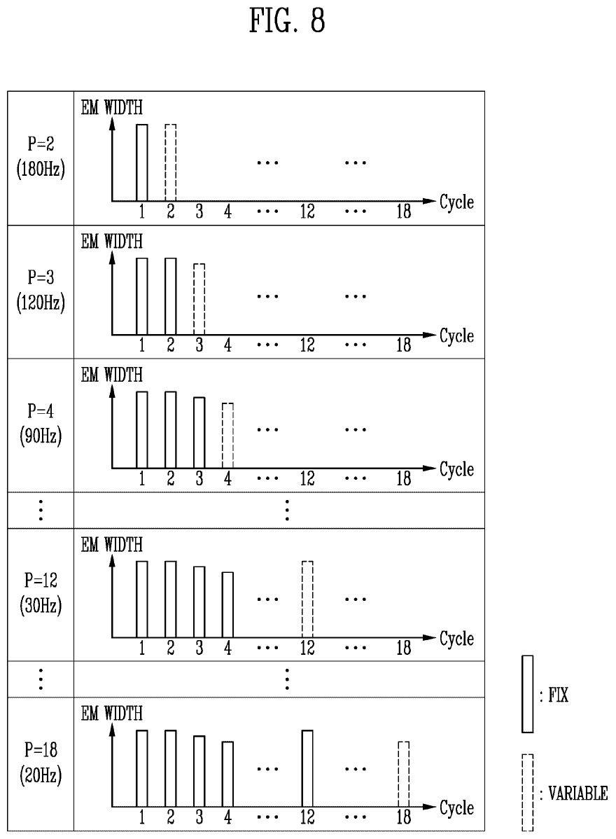

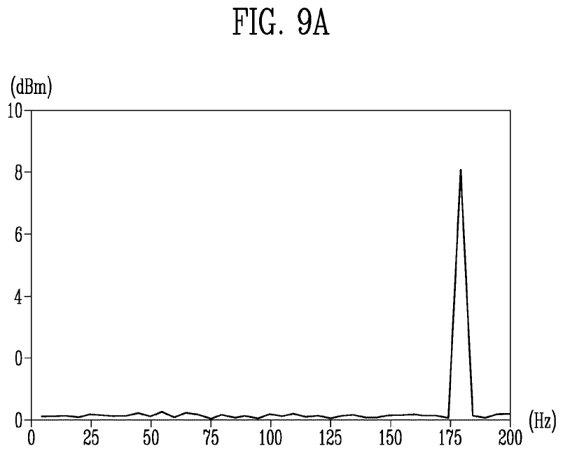

FIG. 7 is a flowchart illustrating a method of setting a width of a disable emission control signal according to an embodiment of the disclosure. FIG. 8 is a diagram illustrating a process of setting the width of the disable emission control signal corresponding to the flowchart of FIG. 7. A y-axis of a graph included in FIG. 8 may represent the width of the disable emission control signal EM, and an x-axis of the graph in FIG. 8 may represent a cycle. FIGS. 9A and 9B are diagrams illustrating a frequency component of 180 Hz and 120 Hz, respectively. In FIGS. 7 and 8, it is assumed that the highest frequency of the display device 100 is 360 Hz and the lowest frequency is 20 Hz.

When the display device 100 is driven at 360 Hz, one cycle (i.e., the write period WP) may be included, and when the display device 100 is driven at 180 Hz, two cycles (i.e., the write period WP and one maintenance period MP) may be included. In addition, when the display device 100 is driven at 20 Hz, eighteen cycles (i.e., the write period WP and seventeen maintenance periods MP) may be included.

The width of the disable emission control signal EM may be set in a process. For example, the width of the disable emission control signal EM may be set either by a separate manufacturing device or by the timing controller 120. For simplicity in this description, it is assumed that the width of the emission control signal is set by the separate manufacturing device.

Referring to FIG. 7, first, the manufacturing device may set P to 2 (S702) (for example, P is a natural number of 2 or more). Here, P may indicate the specific cycle. For example, if P is set to 2, it indicates a second cycle. In this context, P set to 2 would mean that the width of the disable emission control signal EM for the second cycle is set. The width of the disable emission control signal EM included in the write period WP, which corresponds to a first cycle, may be pre-set according to a specification of the display device 100.

After the cycle in which the width of the disable emission control signal EM is to be set is set to the second cycle in steps S702 and S704, the manufacturing device may set the disable emission control signal EM to a first width (S706). Once the disable emission control signal EM is set to the first width, the display device 100 may be operated at a driving frequency (for example, 180 Hz) corresponding to the second cycle. During this operation, the manufacturing device may measure a frequency component (or frequency domain) associated with the second cycle, as shown in FIG. 9A. In FIG. 9A, an x-axis may represent a frequency (Hz) and a y-axis may represent power (dBm). The frequency component corresponding to the disable emission control signal EM with the first width, as measured in step S706, is referred to as “a”.

After the frequency component is measured in step S706, the manufacturing device may set the disable emission control signal EM to a second width (S708). The second width may differ in length (area or time) from the first width. For example, the manufacturing device may gradually increase or decrease the width of the disable emission control signal EM in steps S706 and S708.

After setting the disable emission control signal EM to the second width, the display device 100 may be operated at a driving frequency (for example, 180 Hz) corresponding to the second cycle. The manufacturing device may then measure a frequency component (or frequency domain) associated with the second cycle when the display device 100 is driven. The frequency component corresponding to the disable emission control signal EM with the second width, as measured in step S708, is referred to as “b”.

Thereafter, the manufacturing device may compare the frequency component of “a” and the frequency component of “b”. For example, the manufacturing device may determine whether “a” is greater than “b” (S710). If it is determined that “a” is greater than “b” in step S710, the manufacturing device may repeat steps S706 and S708.

If it is determined that “a” is greater than “b”, this indicates that the frequency component may be further decreased. As the frequency component is decreased, the luminance difference between cycles included in the frame may be minimized, thereby reducing flicker. When it is determined that “a” is greater than “b”, the manufacturing device may set the disable emission control signal EM to the second width in step S706, and then adjust the disable emission control signal EM to a third width, different from both the first width and the second width in step S708.

When it is determined that “a” is less than “b” in step S710, the manufacturing device may set the width of the disable emission control signal EM for the second cycle to the width set in step S706 (for example, the first width). The width of the disable emission control signal EM of the second cycle set in the manufacturing device may be stored in a memory included in the timing controller 120.

After the width of the disable emission control signal EM of the second cycle is set in S712, the manufacturing device may determine whether the second cycle corresponds to the lowest frequency of the display device 100 (S714). When the second cycle does not correspond to the lowest frequency, P may be increased by 1 (S716). When P is increased by 1, the cycle may correspond to the third cycle (S704).

Thereafter, the manufacturing device may set the width of the emission control signal corresponding to the third cycle while repeating steps S704 to S714 described above. However, in steps S706 and S708, the display device 100 may be driven at a driving frequency (for example, 120 Hz) corresponding to the third cycle, and the manufacturing device may measure a frequency component corresponding to the third cycle as shown in FIG. 9B. In FIG. 9B, an x-axis may represent a frequency (Hz) and a y-axis may represent power (dBm).

Thereafter, the manufacturing device may set a width of an emission control signal corresponding to each of a fourth cycle (for example, corresponding to 90 Hz), . . . , a twelfth cycle (for example, corresponding to 30 Hz), . . . , and an eighteenth cycle (for example, corresponding to 20 Hz) while repeating the process described above.

In an embodiment of the disclosure described above, the frequency component may be measured while varying the width of the emission control signal to at least two different widths corresponding to the P-th cycle. The width of the emission control signal that results in the lowest frequency component may then be selected as the width of the emission control signal for the P-th cycle. During this process, the display device may be driven at the driving frequency corresponding to the P-th cycle, and the manufacturing device may measure the frequency component corresponding to the P-th cycle.

The manufacturing device may adjust the width of the emission control signal for each cycle by incrementally increasing the value of P. In this way, the width of the emission control signal for each cycle of the display device 100 may be set based on the driving frequency of the corresponding cycle. For example, when the display device 100 operates at the lowest frequency (for example, 20 Hz), the width of the disable emission control signal EM supplied during one frame period may be set by considering all frequencies between the highest frequency and the lowest frequency. Thus, in this embodiment, the width of the emission control signal is set with consideration for the various driving frequencies of the display device 100, and thus flicker may be minimized.

If the corresponding cycle matches the lowest frequency of the display device 100 in step S714, the process of setting the width of the disable emission control signal EM may be ended (S718).

In another embodiment of the disclosure, a disable emission control signal EM having a width different from that of the disable emission control signal EM supplied in the first cycle may be supplied in at least one remaining (e.g., subsequent) cycle adjacent to the first cycle, such as the second cycle, the third cycle, or the fourth cycle.

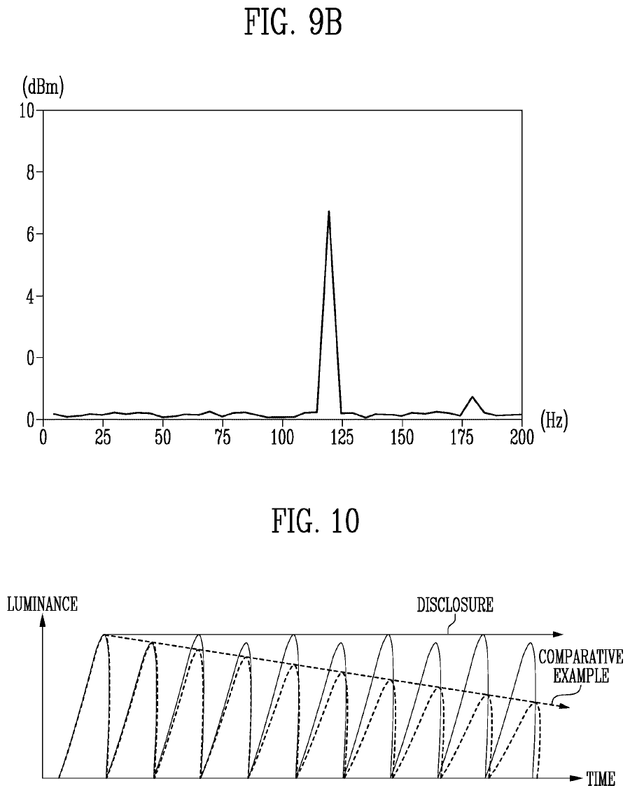

FIG. 10 is a diagram illustrating the luminance of one frame period of a display device according to a comparative example and an embodiment of the disclosure. In FIG. 10, the comparative example represents a scenario where the width of the emission control signal is set according to the lowest frequency of the display device, while the embodiment of the disclosure represent a scenario where the width of the emission control signal is set using the process described in FIG. 7. In FIG. 10, a y-axis may represent a luminance, and an x-axis may represent a time.

Referring to FIG. 10, in the comparative example, the luminance may be gradually decreased in one frame, and thus flicker may be recognized by a user.

On the other hand, when the width of the emission control signal is set in consideration of all driving frequencies, as in an embodiment of the disclosure, the luminance of each cycle within one frame can be made approximately similar. This approach minimizes flicker in the display device 100, thereby improving overall display quality.

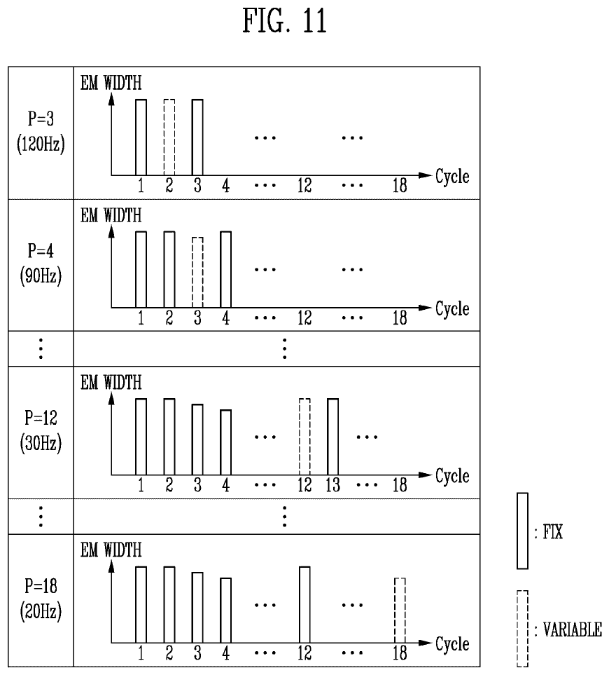

FIG. 11 is a diagram illustrating a method of setting a width of a disable emission control signal according to an embodiment of the disclosure.

Referring to FIG. 11, the width of the disable emission control signal EM of the first cycle may be set in advance. For example, the first cycle may be the write period WP, and the width of the disable emission control signal EM included in the write period WP may be set in advance to correspond to the specification of the display device 100.

In FIG. 11, after the width of the disable emission control signal EM of the (P+1)-th cycle is fixed to a predetermined width, the width of the disable emission control signal EM for the P-th cycle may be set. For example, after fixing the width of the disable emission control signal EM for the third cycle to a predetermined width, the width of the disable emission control signal EM for the second cycle may be set. Here, the width of the disable emission control signal EM for the (P+1)-th cycle may be the same as the width of the disable emission control signal EM for the first cycle.

More specifically, the width of the disable emission control signal EM for the first cycle and the third cycle may be fixed to a predetermined width during a period in which the width of the disable emission control signal EM for the second cycle is set. After the width of the disable emission control signal EM for the first cycle and the third cycle is fixed to a predetermined width, the width of the disable emission control signal EM for the second cycle can be adjusted. Here, the width of the disable emission control signal EM of the second cycle may be set through the process shown in FIG. 7.

When the width of the disable emission control signal EM for the second cycle is set (or when the frequency component is measured), the display device 100 may be driven at 120 Hz. In addition, a control device may set the width of the disable emission control signal EM for the second cycle using a frequency component of 180 Hz.

The luminance of the last cycle in a current frame period may have a predetermined difference from the luminance of the first cycle in the next frame. In an embodiment of the disclosure, after the width of the disable emission control signal EM of the (P+1)-th cycle is fixed to a predetermined width, the width of the disable emission control signal EM of the P-th cycle may be set, so that the luminance difference between frames may be minimized.

Similarly, the width of the fourth cycle disable emission control signal EM may be set to a predetermined width during the period in which the width of the third cycle disable emission control signal EM is set. In addition, the width of the thirteenth cycle disable emission control signal EM may be set to a predetermined width during a period in which the width of the twelfth cycle disable emission control signal EM is set. Finally, the width of the disable emission control signal EM of the last cycle (for example, the eighteenth cycle) may be set by varying the width of the disable emission control signal EM of the last cycle.

In FIG. 11, the width of the disable emission control signal EM for the P-th cycle is set after the width of the disable emission control signal EM for the (P+1)-th cycle is fixed to a predetermined width. The other operational steps may be the same as those shown in FIG. 8 (or FIG. 7).

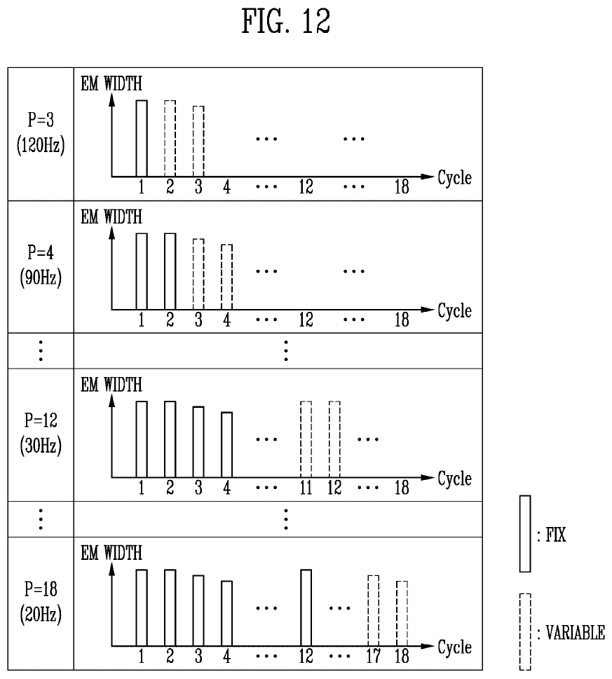

FIG. 12 is a diagram illustrating a method of setting a width of a disable emission control signal according to an embodiment of the disclosure.

Referring to FIG. 12, in an embodiment of the disclosure, the width of the emission control signal may be set by varying the width of the emission control signal of at least two cycles. For example, when the width of the disable emission control signal EM of the P-th cycle is set, the width of the P-th disable emission control signal EM and the width of the (P+1)-th disable emission control signal EM may be varied.

For example, while setting the width of the disable emission control signal EM for the second cycle, the frequency component of the second cycle can be measured by varying the width of the disable emission control signal EM for both the second and third cycles. The width of the disable emission control signal EM for the second cycle may then be set to achieve a low-frequency component.

For example, while setting the width of the disable emission control signal EM for the third cycle, the frequency component of the third cycle can be measured by varying the width of the disable emission control signal EM for both the third and fourth cycles. The width of the disable emission control signal EM for the third cycle may then be set to achieve a low-frequency component.

For example, while setting the width of the disable emission control signal EM for the eleventh cycle, the frequency component of the eleventh cycle can be measured by varying the width of the disable emission control signal EM for both the eleventh and twelfth cycles. The width of the disable emission control signal EM for the eleventh cycle may then be set to achieve a low-frequency component.

Finally, the frequency components of the seventeenth and eighteenth cycles may be measured by varying the width of the disable emission control signal EM for both the seventeenth and eighteenth cycles during the period in which the width of the disable emission control signal EM of the last cycle (for example, the eighteenth cycle) is set. The widths of the disable emission control signals EM for the seventeenth and eighteenth cycles may then be set to have a low frequency component.

While the foregoing has been described in connection with specific embodiments of the disclosure, those skilled in the art will recognize that various modifications and changes can be made without departing from the spirit and scope of the disclosure described in the claims.

What is claimed is:

1. A display device comprising:
pixels connected to scan lines, data lines, and emission control lines;
a data driver configured to supply a data signal to the data lines during a first cycle of a frame;
an emission driver configured to supply a disable emission control signal and an enable emission control signal to the emission control lines during the first cycle and at least one other cycle within the frame,
wherein the emission driver supplies the disable emission control signal with a first width during the first cycle, and with a second width different from the first width during at least one other cycle adjacent to the first cycle.

2. The display device according to claim 1, wherein the first cycle is a period in which a voltage of the data signal is stored in the pixels, and the at least other cycle is a period in which the pixels emit light and do not emit light while maintaining the voltage of the data signal.

3. The display device according to claim 1, wherein the at least other cycle adjacent to the first cycle is a second cycle, a third cycle, or a fourth cycle.

4. The display device according to claim 1, wherein the pixels do not emit light when the disable emission control signal is supplied to the emission control lines, and the pixels emit light when the enable emission control signal is supplied to the emission control lines.

5. A display device comprising:
pixels connected to scan lines, data lines, and emission control lines;
a data driver configured to supply a data signal to the data lines;
an emission driver configured to supply a plurality of disable emission control signals and a plurality of enable emission control signals to the emission control lines during one frame period,
wherein at least one of the plurality of disable emission control signals has a first width, and at least one of the plurality of disable emission control signals has a second width different from the first width.

6. The display device according to claim 5, wherein at least one of the plurality of disable emission control signals has a third width different from the first width and the second width.

7. The display device according to claim 5, wherein the emission driver sets a first disable emission control signal within the frame period to the first width.

8. The display device according to claim 7, wherein the emission driver sets at least one of a second disable emission control signal, a third disable emission control signal, and a fourth disable emission control signal within the frame period to the second width.

9. The display device according to claim 5, wherein the pixels do not emit light when the disable emission control signal is supplied to the emission control lines, and the pixels emit light when the enable emission control signal is supplied to the emission control lines.

10. A method of setting an emission control signal of a display device, wherein one frame includes a first cycle in which a data signal is supplied to pixels and a plurality of remaining cycles in which the pixels alternately emit and do not emit light while maintaining the data signal, the method comprising:
measuring a frequency component while varying a width of the disable emission control signal to at least two different widths in response to a P-th cycle (where P is a natural number of 2 or more) within the remaining cycles; and
setting the width of the disable emission control signal to a width that results in a lower frequency component for the P-th cycle.

11. The method according to claim 10, wherein the frequency component corresponding to the P-th cycle is measured when measuring the frequency component.

12. The method according to claim 10, wherein the disable emission control signal has a voltage that turns off the pixels when it is applied to the pixels.

13. The method according to claim 10, wherein a width of an emission control signal within the first cycle is predetermined.

14. The method according to claim 10, wherein a width of an emission control signal for the P-th cycle is set when a width of an emission control signal for a (P+1)-th cycle is predetermined.

15. The method according to claim 14, wherein the width of the emission control signal for the (P+1)-th cycle is equal to the width of the emission control signal for the first cycle.

16. The method according to claim 10, wherein a width of an emission control signal for a (P+1)-th cycle is varied when a width of an emission control signal for the P-th cycle is set.

17. A display device comprising:
pixels connected to scan lines, data lines, and emission control lines;
a data driver configured to supply a data signal to the data lines during a first period of a frame;
an emission driver configured to supply a disable signal and an enable signal to the emission control lines during the first period and at least one additional period within the frame,
wherein the emission driver supplies the disable signal with a first duration during the first period, and supplies the disable signal with a different duration during the at least one additional period within the frame.
